(19) United States
(12) Patent Application Publication
(10) Pub. No.: US 2016/0185320 A1
(43) Pub. Date: Jun. 30, 2016

(54) WIPER BLADE

(71) Applicant: KCW Corporation, Daegu (KR)

(72) Inventor: Jae-Hyuck AN, Daegu (KR)

(21) Appl. No.: 14/967,129

(22) Filed: Dec. 11, 2015

(30) Foreign Application Priority Data
Dec. 30, 2014 (KR) 10-2014-0193784

(51) Int. Cl. B60S 1/40

(52) U.S. Cl. CPC B60S 1/40; B60S 2001/4093

(57) ABSTRACT

A wiper blade may be provided that includes: a main lever which is fastened to a wiper arm auxiliary levers which are connected to the main lever; connection members which connect the main lever and the auxiliary levers; a plurality of yoke levers which are coupled to the main lever and the auxiliary levers; and a wiper strip which is supported by the plurality of yoke levers. The connection members include: a base; and a pair of fixing portions which extends from the base and is inserted and fixed to the main lever and the auxiliary levers respectively. As a result, the number of the parts can be reduced, and an assembly process can be simpler and the productivity can be enhanced. A gap at the time of coupling the wiper arm and the wiper blade can be improved, so that a wipe problem can be also solved.

### CROSS-REFERENCE TO RELATED APPLICATION

This application claims priority to Republic of Korea Patent Application No. 10-2014-0193784 filed on Dec. 30, 2014, which is incorporated by reference herein in its entirety.

### BACKGROUND

1. Field

The present invention relates to a wiper blade, and more particularly to a load transfer wiper blade using a spring.

2. Description of Related Art

In general, a wiper blade removes impurities, snow, rain or the like when driving and prevents a driver's front sight from being deteriorated. A conventional wiper blade performs a repetitive reciprocating action in a fan shape as a motor drives a link apparatus connected to a wiper arm.

In a conventional wiper blade, a pair of metallic baking plates is coupled to a rubber-made wiper strip. The baking plate is supported by a plurality of yoke members. The yoke members are connected to each other by means of a plurality of levers.

Here, with regard to the conventional wiper blade, through use of a pin or a rivet, the yoke member and an auxiliary lever are rotatably coupled to each other, and auxiliary levers are rotatably coupled to each other. A spacer and the like which have a small friction coefficient is coupled to the coupling portion in order to reduce frictional resistance. Therefore, the number of parts constituting one wiper blade is as many as 20 and at least 15. Since the conventional wiper blade uses a metallic main lever and a metallic sub lever, the wiper blade is heavy.

The wiper blade which has a lot of parts and large weight gives a load to the wiper arm as well as a glass surface of the vehicle when the wiper blade is installed in the vehicle. As a result, breakdown may occur and the life span of the product may be shortened. Accordingly, a light wiper blade having an excellent assemblability is required to be developed.

### SUMMARY

One embodiment is a wiper blade including: a main lever which is fastened to a wiper arm; auxiliary levers which are connected to the main lever; connection members which connect the main lever and the auxiliary levers; a plurality of yoke levers which are coupled to the main lever and the auxiliary levers; and a wiper strip which is supported by the plurality of yoke levers. The connection members may include: a base; and a pair of fixing portions which extends from the base and is inserted and fixed to the main lever and the auxiliary levers respectively.

Also, the base may have an arch shape.

The main lever and the auxiliary levers may include fixing grooves. The pair of fixing portions is inserted and fixed respectively to the fixing grooves formed in the main lever and the auxiliary levers, so that the main lever may be connected to the auxiliary levers.

Also, the pair of fixing portions may include an elastic protrusion.

The main lever and the auxiliary levers may include, respectively, a catching protrusion by which the protrusion is caught and fastened.

Also, the connection members may be made of an elastic material.

Also, the connection members may be leaf springs.

### BRIEF DESCRIPTION OF THE DRAWINGS

FIG. 1 is a perspective view of a wiper blade according to an embodiment of the present invention;

FIG. 2 is an exploded perspective view of the wiper blade according to the embodiment of the present invention;

FIG. 3 is an exploded view of the wiper blade according to the embodiment of the present invention, for describing coupling relations between components;

FIGS. 4a and 4b are configuration views showing an enlarged coupling portion between a main lever and an auxiliary lever in the wiper blade according to the embodiment of the present invention;

FIGS. 5a and 5b are views showing a shape of a connection member which is one component of the wiper blade according to the embodiment of the present invention; and

FIG. 6 is a view for describing a principle in which a force is transferred in the wiper blade according to the embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. The following detailed description is not intended to be limited. If adequately described, the scope of the present invention is limited only by the appended claims of the present invention as well as all equivalents thereto. Similar reference numerals in the drawings designate the same or similar functions in many aspects.

Also, in the components of the present invention, detailed descriptions of what can be clearly understood and easily carried into practice by those skilled in the art will be omitted to avoid making the subject matter of the present invention unclear.

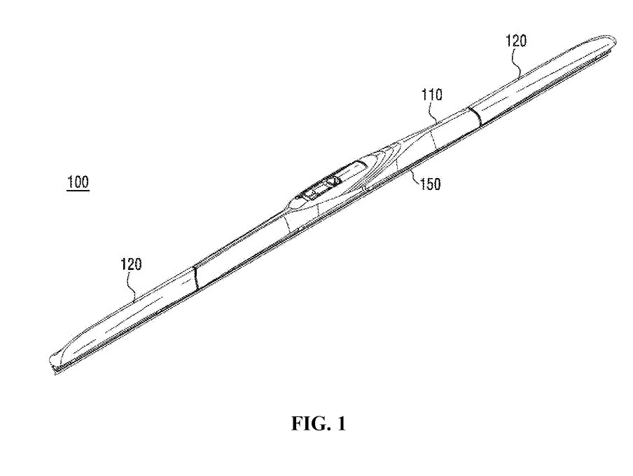

FIG. 1 is a perspective view of a wiper blade 100 according to an embodiment of the present invention. As shown in FIG. 1, the wiper blade 100 according to an embodiment of the present invention includes a main lever 110, an auxiliary lever 120, and a wiper strip 150.

The wiper blade 100 according to the embodiment of the present invention is connected to an end of a wiper arm (not shown) and receives a pressure from the wiper arm in a direction of a glass surface of a vehicle. The wiper arm performs a reciprocating action in a fan shape at a predetermined angle by a motor. Accordingly, the wiper blade 100 wipes the glass of the vehicle with the contact with the glass of the vehicle. That is, in order to wipe while applying a pressure in close contact with the glass of the vehicle, the pressure load added from the wiper arm should be transferred to the entire length of the wiper strip 150.

In the wiper blade 100 according to the embodiment of the present invention, the pressure load is transferred to both ends of the wiper strip 150 not by a conventional tournament type connection but by a connection member which is used to connect the main lever 110 with the auxiliary lever 120.

Through the wiper blade 100 according to the embodiment of the present invention, which uses the connection member capable of efficiently transferring the pressure load, the number of the parts, for example, a yoke lever, etc., can be reduced.

As the structure of the wiper blade 100 becomes simpler, an assembly process thereof can be simpler and the productivity thereof can be enhanced. Also, as the entire weight and height of the wiper blade 100 are reduced, a gap at the time of coupling the wiper arm “A” and the wiper blade 100 has a room to be improved. Further, a wiping problem can be also solved.

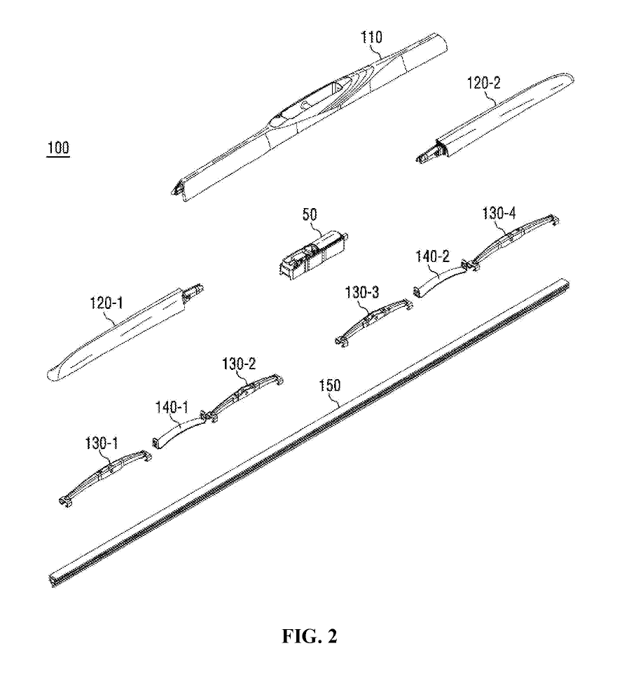

FIG. 2 is an exploded perspective view of the wiper blade 100 according to the embodiment of the present invention. As shown in FIG. 2, the wiper blade 100 according to the embodiment of the present invention includes the main lever 110, the auxiliary lever 120, a plurality of yoke levers 130, a connection member 140, and the wiper strip 150.

The main lever 110 is connected to the wiper arm. Specifically, an adaptor 50 which is assembled in a central axis of the main lever 110 receives a variety of arms, for example, a U-hook type wiper arm, a side pin-hole type arm, etc. An axial coupling groove formed in the center of the adaptor 50 is coupled to the central axis of the main lever 110, and the adaptor 50 is assembled rotatably with respect to the main lever 110. As various wiper arms are fastened to the adaptor 50, the wiper arm is coupled to the wiper blade 100 according to the embodiment of the present invention. Meanwhile, the adaptor is formed to receive wiper arms of various sizes.

The main lever 110 is directly coupled to the yoke lever 130 and applies a pressure applied from the wiper arm to the yoke lever 130. Also, the main lever 110 applies the pressure applied from the wiper arm to the auxiliary levers 120-1 and 120-2 connected to the main lever 110 by the connection member 140. As will be described below, the connection members 140-1 and 140-2 function to efficiently transfer the pressure applied to the main lever 110 to the auxiliary levers 120-1 and 120-2.

The main lever 110 may include a spoiler (not shown). The spoiler may be implemented by processing the shape of the top surface of the main lever 110. When the wiping is performed, the spoiler induces air flow into the glass surface of the vehicle, and thus, the main lever 110 is pressed and closely contacted with the glass surface of the vehicle.

The auxiliary levers 120-1 and 120-2 are connected to the main lever 110. The auxiliary levers 120-1 and 120-2 are connected to the yoke levers 130-1, 130-2, 130-3, and 130-4 and transfer the pressure received from the main lever 110 to the yoke levers 130-1, 130-2, 130-3, and 130-4. As will be described below, the connection members 140-1 and 140-2 function to efficiently transfer the pressure from the main lever 110 to the auxiliary levers 120-1 and 120-2.

The auxiliary levers 120-1 and 120-2 may include the spoiler. The spoiler may be implemented by processing the shape of the top surfaces of portions of the auxiliary levers 120-1 and 120-2. When the wiping is performed, the spoiler induces air flow into the glass surface of the vehicle, and thus, the auxiliary levers 120-1 and 120-2, together with the main lever 110, are pressed and closely contacted with the glass surface of the vehicle.

The main lever 110 and the auxiliary levers 120-1 and 120-2 may be made of a resin material.

The plurality of yoke levers 130-1, 130-2, 130-3, and 130-4 support the wiper strip 150. More specifically, the plurality of yoke levers 130-1, 130-2, 130-3, and 130-4 press the wiper strip 150 and supports the wiper strip 150 in such a manner as to be slidable. The yoke levers 130-1, 130-2, 130-3, and 130-4 may be made of a resin material and may be injection-molded.

The plurality of yoke levers 130-1, 130-2, 130-3, and 130-4 are connected to the main lever 110 and the auxiliary levers 120-1 and 120-2 are formed separately from each other. While the total of four yoke levers 130-1, 130-2, 130-3, and 130-4 are shown in the drawings, the number of the yoke levers may be changed according to the size or curvature of the glass surface of the vehicle.

The yoke levers 130-2 and 130-3 which are connected to the main lever 110 among the plurality of yoke levers 130-1, 130-2, 130-3, and 130-4 transfer the pressure received from the wiper arm by the main lever 110 to the wiper strip 150. A pressure which is applied to the central axis of the main lever 110 may be directly transferred to the wiper strip 150 through the yoke levers 130-2 and 130-3.

Meanwhile, the pressure that the auxiliary levers 120-1 and 120-2 have received is transferred to the yoke lever 130-1 and 130-4 connected to the auxiliary levers 120-1 and 120-2 by the connection members 140-1 and 140-2. That is to say, the auxiliary levers 120-1 and 120-2 transfer the pressure received from the main lever 110 through the connection members 140-1 and 140-2 to the yoke lever 130-1 and 130-4 connected to the auxiliary levers 120-1 and 120-2. The yoke lever 130-1 and 130-4 apply the received pressure to the wiper strip 150 and support the wiper strip 150 toward the glass surface of the vehicle.

The connection members 140-1 and 140-2 connect the main lever 110 and the auxiliary levers 120-1 and 120-2. The connection members 140-1 and 140-2 are comprised of a base and fixing ends provided on both ends of the base.

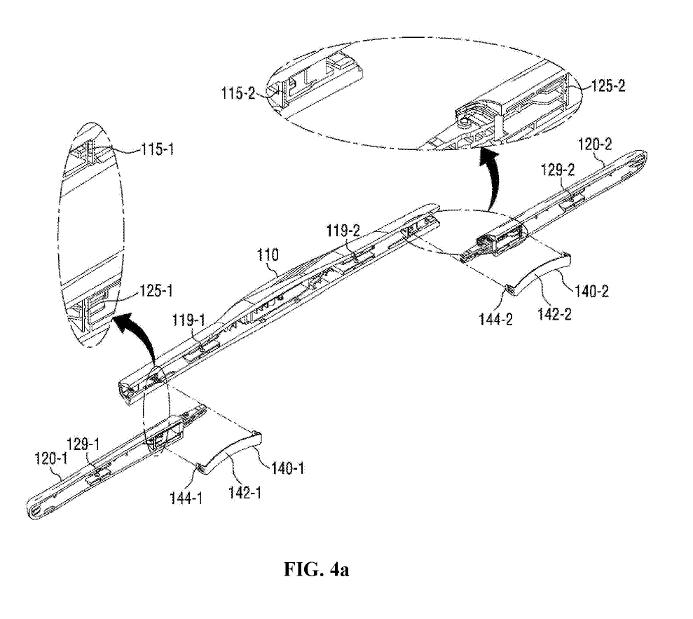

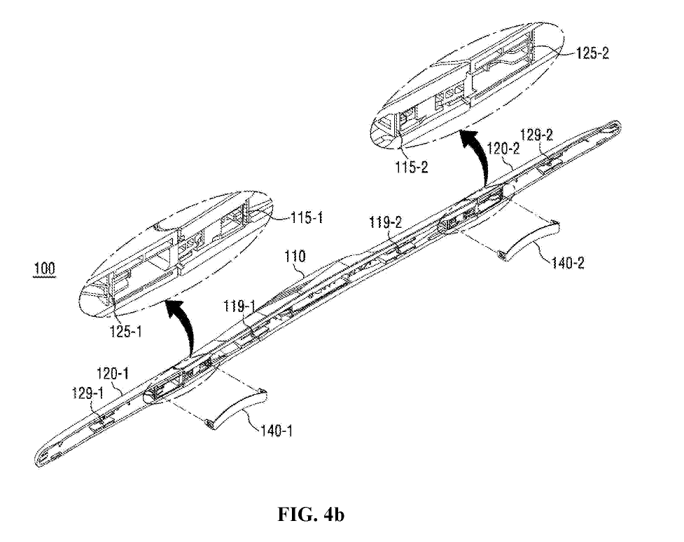

The fixing ends provided on both ends of the base of the connection member 140-1 are inserted and fixed to the main lever 110 and the auxiliary lever 120-1 respectively. The fixing ends provided on both ends of the base of another connection member 140-2 are inserted and fixed to the main lever 110 and the auxiliary lever 120-2 respectively. Accordingly, the main lever 110 and the auxiliary levers 120-1 and 120-2 are interconnected to each other. The configurations and shapes of the connection members 140-1 and 140-2 will be described in more detail with reference to FIGS. 4a and 4b.

The wiper strip 150 extends in the longitudinal direction thereof and may be made of either an elastic material like rubber or an elastic composite material. The wiper strip 150 is supported by the plurality of yoke levers 130-1, 130-2, 130-3, and 130-4 and wipes the glass surface of the vehicle while applying the pressure to the glass surface of the vehicle.

The shape of the wiper strip 150 is not limited to a specific embodiment. The wiper strip 150 may have various detailed configurations.

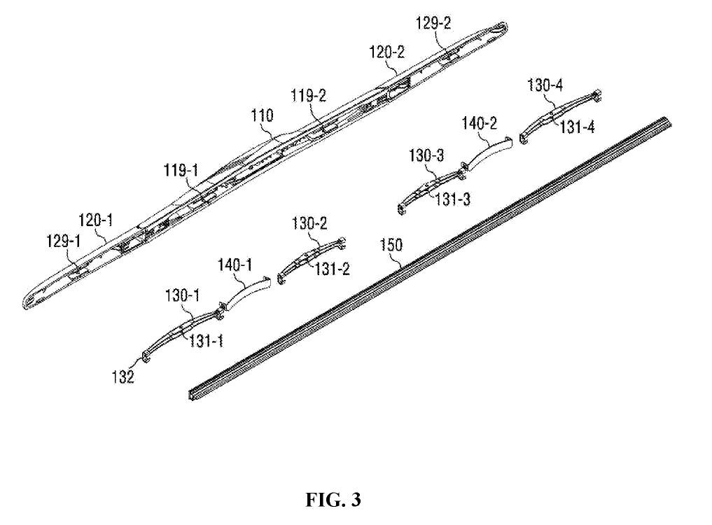

FIG. 3 is an exploded view of the wiper blade 100 according to the embodiment of the present invention, for describing coupling relations between components.

Specifically, FIG. 3 is an exploded view showing that the wiper strip 150, the plurality of yoke levers 130-1, 130-2, 130-3, and 130-4, and the connection members 140-1 and 140-2 have been separated from each of the levers 110, 120-1, and 120-2.

The wiper strip 150 is supported by the plurality of yoke levers 130-1, 130-2, 130-3, and 130-4. For the purpose of avoid making the subject matter of the present invention unclear, many configurations of the wiper strip 150 are omitted in FIG. 3.

Briefly describing, the wiper strip 150 may include a wiper lip (not shown) which directly contacts with the glass surface of the vehicle and wipes, and a base (not shown) which is supported by the plurality of yoke levers. Also, the wiper strip 150 may include a receiving groove in which backing plates parallel to each other are received.

The rectangular backing plate which has spring properties and is made of a metallic material may be received in the receiving groove formed in the wiper strip 150 in the longitudinal direction thereof.

The backing plate applies elasticity and rigidity to the wiper lip. When a pressure is applied from the wiper arm “A”, the pressure is distributed to the wiper strip 150 through the plurality of levers. Here, the pressure which is transferred is distributed by the backing plate in the longitudinal direction of the wiper strip.

The backing plate efficiently transfers the pressure to the entire longitudinal surface of the wiper strip 150 and functions to maintain the shape of the wiper strip 150. Various number of the backing plates and receiving grooves may be provided according to the rigidity or elasticity of the wiper strip 150.

A pair of fasteners 132 is formed on both ends of the plurality of yoke levers 130-1, 130-2, 130-3, and 130-4. The pair of fasteners 132 supports the wiper strip 150 in such a manner as to be slidable.

Catching grooves 131-1, 131-2, 131-3, and 131-4 formed in the central portion of the plurality of yoke levers 130-1, 130-2, 130-3, and 130-4 are coupled to catching projections 119-1, 119-2, 129-1, and 129-2 formed on the main lever 110 and the auxiliary levers 120-1 and 120-2. The main lever 110 and the yoke levers 130-2 and 130-3 are rotatably coupled to each other with the axis of a coupling portion of the catching groove and the catching projection. The auxiliary levers 120-1 and 120-2 and the yoke levers 130-1 and 130-4 are rotatably coupled to each other with the axis of a coupling portion of the catching groove and the catching projection.

The connection members 140-1 and 140-2 connect the main lever 110 and the auxiliary levers 120-1 and 120-2. FIGS. 4a and 4b show enlarged coupling portions according to the connection members 140-1 and 140-2.

As will be described later, the connection members 140-1 and 140-2 are comprised of a base 142 and a pair of fixing portions 144. The pair of the fixing portions 144-1 of the connection member 140-1 is inserted and fixed to a fixing groove 115-1 of the main lever 110 and a fixing groove 125-1 of the auxiliary lever 120-1 respectively. The pair of the fixing portions 144-2 of another connection member 140-2 is inserted and fixed to a fixing groove 115-2 of the main lever 110 and a fixing groove 125-2 of the auxiliary lever 120-2 respectively. Accordingly, the fixing portions 144-1 and 144-2 are inserted and fixed to the fixing grooves 115-1, 115-2, 125-1, and 125-2 of the main lever 110 and the auxiliary levers 120-1 and 120-2, so that the main lever 110 is connected to the auxiliary levers 120-1 and 120-2 in the form of a bridge.

More specifically, as shown in FIG. 4a, the main lever 110 includes the fixing grooves 115-1 and 115-2, and the auxiliary levers 120-1 and 120-2 include the fixing grooves 125-1 and 125-2. The pair of fixing portions 144-1 provided on both ends of the base 142-1 of the connection member 140-1 connect the main lever 110 and the auxiliary lever 120-1 by being inserted into the fixing grooves 115-1 and 125-1 of the main lever 110 and the auxiliary lever 120-1 respectively.

Also, the pair of fixing portions 144-2 provided on both ends of the base 142-2 of the connection member 140-2 connect the main lever 110 and the auxiliary lever 120-2 by being inserted into the fixing grooves 115-2 and 125-2 of the main lever 110 and the auxiliary lever 120-2 respectively.

As shown in FIG. 4b, the fixing grooves 115-1, 115-2, 125-1, and 125-2 are formed in positions of the main lever 110 and auxiliary levers 120-1 and 120-2, which are suitable for the fixing portion 144 of the connection members 140-1 and 140-2 to be inserted and fixed to. The connection members 140-1 and 140-2 may have an arch shape and may be made of an elastic member. More specifically, the connection members 140-1 and 140-2 may be leaf springs.

In particular, when a force is applied to the elastic arch-shaped connection members 140-1 and 140-2, the restoring force of the elastic arch-shaped connection members 140-1 and 140-2 allows more force to be transferred in the direction in which the force is applied. Therefore, the elastic arch-shaped connection members 140-1 and 140-2 very efficiently transfers the force received from the main lever 110 to the auxiliary levers 120-1 and 120-2.

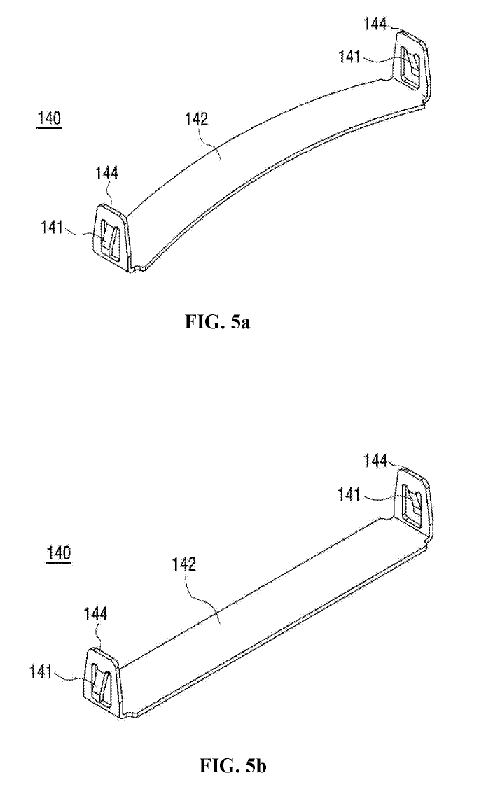

Meanwhile, the connection members 140-1 and 140-2 may further a protrusion (shown in FIGS. 5a and 5b) which causes the connection members 140-1 and 140-2 to be inserted and fixed to the fixing grooves 115-1, 115-2, 125-1, and 125-2 of the main lever 110 and the auxiliary levers 120-1 and 120-2.

In response to this, a catching protrusion (not shown) by which the protrusion of the connection members 140-1 and 140-2 is caught and fastened may be formed on the fixing grooves 115-1, 115-2, 125-1, and 125-2 of the main lever 110 and the auxiliary levers 120-1 and 120-2. The catching protrusion (not shown) may have any shape by which the protrusion is caught and fastened.

As such, through use of the connection members 140-1 and 140-2 capable of efficiently transferring the pressure load, each of the yoke levers 130-1, 130-2, 130-3, and 130-4 is directly connected to the main lever 110 and the auxiliary levers 120-1 and 120-2 without necessity of a separate lever which connects between the main lever 110 and the auxiliary levers 120-1 and 120-2, so that the number of the parts constituting the wiper blade 100 can be reduced.

As the structure of the wiper blade 100 becomes simpler, an assembly process thereof can be simpler and the productivity thereof can be enhanced. Also, as the entire weight and height of the wiper blade 100 are reduced due to the reduction of the number of the parts of the wiper blade 100, a gap at the time of coupling the wiper arm “A” and the wiper blade 100 has a room to be improved. Further, a wipe problem can be also solved.

In the foregoing, it has been shown that the fixing portion 144 of the connection members 140-1 and 140-2 is inserted upward toward the lower portion of each of the levers 110, 120-1, and 120-2. Additionally, it can be considered that the fixing portion 144 is inserted downward into the levers 110, 120-1, and 120-2. In this case, the positions or shapes of the fixing grooves 115-1, 115-2, 125-1, and 125-2 formed in the levers 110, 120-1, and 120-2 may be changed. Besides, the connection members 140-1 and 140-2 may be inserted downward toward the upper portion of each of the levers 110, 120-1, and 120-2. It is apparent to those skilled in the art that the wiper blade 100 according to the embodiment of the present invention achieves the same technical effect by any one of the above-mentioned coupling structures.

Also, each of the levers 110, 120-1, and 120-2 is fastened with respect to the connection members 140-1 and 140-2 in a sliding manner, so that the main lever 110 can be connected to the auxiliary levers 120-1 and 120-2. In this case, the fixing portion 144 of the connection members 140-1 and 140-2 may have a shape extending from the base 142 in a straight line. Also, the fixing portion 144 may extend from the base 142 in a straight line, and the base 142 may have an arch shape.

FIGS. 5a and 5b are views showing various shapes of the connection member 140 which is one component of the wiper blade 100 according to the embodiment of the present invention.

As shown in FIG. 5a, the connection member 140 includes the base 142 and the fixing portion 144 formed at both ends of the base 142. The pair of the fixing portions 144 extends from the base 142 and is bent at both ends of the base 142.

FIG. 5a shows that the pair of the fixing portions 144 is integrally formed with the base 142. Additionally, the base 142 and the pair of the fixing portions 144 may be separate entities respectively. In this case, they may be connected to each other by an appropriate means. Also, the base 142 and the pair of the fixing portions 144 may be made of the same material or different materials.

FIG. 5a shows the arch-shaped connection member 140. That is, the convex central portion of the base 142 rises up.

The shape of the connection member 140 is suitable for transferring a force (pressure) applied to the central portion of the base 142 to both ends of the base 142. In other words, due to the arch-shaped structure of the elastic base 142, the force (pressure) applied to the central portion of the base 142 can be efficiently transferred to both ends (to the fixing portion).

The fixing portion 144 at both ends of the base 142 may include a protrusion 141. The protrusion 141 is formed by cutting a portion of the fixing portion 144 and protrudes outwardly. The protrusion 141 has a cantilever shape of which an end is connected to the fixing portion 144. The protrusion 141 protrudes outwardly from the fixing portion 144 and has an elastic force acting in the protruding direction.

When the fixing portion 144 is inserted into the fixing grooves 115-1, 115-2, 125-1, and 125-2 of the main lever 110 and the auxiliary levers 120-1 and 120-2, the protrusion 141 has an inclined surface such that the fixing portion 144 is easily curved by the side walls of the fixing grooves 115-1, 115-2, 125-1, and 125-2. The inclined surface helps the fixing portion 144 to be easily inserted into the fixing grooves 115-1, 115-2, 125-1, and 125-2. The inserted fixing portion 144 restores its original shape by the elastic force in the inner space of the fixing grooves 115-1, 115-2, 125-1, and 125-2.

The restoring force causes the fixing portion 144 to be pushed outward within the inner space of the fixing grooves 115-1, 115-2, 125-1, and 125-2, and the other end of the protrusion 141 is caught by the catching protrusion (not shown) of the fixing grooves 115-1, 115-2, 125-1, and 125-2, so that the fixing portion 144 is not separated from the fixing grooves 115-1, 115-2, 125-1, and 125-2.

FIG. 5b shows another shape of the connection member 140. Unlike FIG. 5a, FIG. 5b shows that the base 142 has a straight line shape. The connection member 140 having the straight line shaped base 142 includes the fixing portion 144 and the protrusion 141.

The fixing portion 144 is bent to extend from both ends of the straight line shaped base 142. The protrusion 141 is formed on a portion of the fixing portion 144. The shapes and functions of the fixing portion 144 and the protrusion 141 may be the same as those of the arch-shaped connection member 140. A detailed description thereof will be omitted.

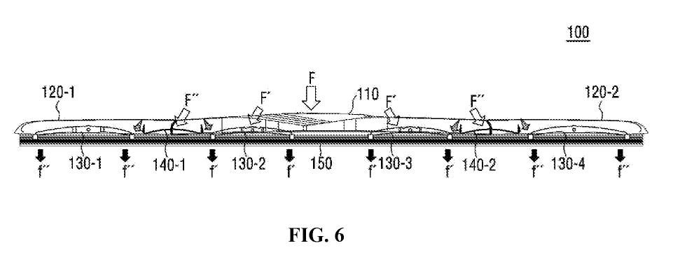

FIG. 6 is a view for describing a process (principle) in which a force is transferred in the wiper blade 100 according to the embodiment of the present invention.

The load pressure “F” applied from the wiper arm “A” passes through the adaptor 50 and is transmitted to the main lever 110 connected to the wiper arm “A”. The main lever 110 transmits the pressure “F” applied from the wiper arm “A” as a pressure “F′” to the yoke levers 130-2 and 130-3 connected directly to the main lever 110 and transmits the pressure “F” as a pressure “F″” to the connection members 140-1 and 140-2.

The yoke levers 130-2 and 130-3 transmit the pressure “F′” received from the main lever 110 as a pressure “f′” to the wiper strip 150 fastened to the yoke levers 130-2 and 130-3.

The connection members 140-1 and 140-2 transmits the received pressure “F″” to the auxiliary levers 120-1 and 120-2. The elastic connection members 140-1 and 140-2 is able to efficiently apply the received pressure “F″” to the auxiliary levers 120-1 and 120-2. Particularly, the elastic arch-shaped connection members 140-1 and 140-2 is able to efficiently transmit the force (pressure).

The auxiliary levers 120-1 and 120-2 transmits the pressure “F″” received from the connection members 140-1 and 140-2 to the yoke levers 130-1 and 130-4 connected directly to the auxiliary levers 120-1 and 120-2. Then, the yoke levers 130-1 and 130-4 transmits the received pressure as a pressure “f″” to the wiper strip 150.

Consequently, the yoke levers 130-1, 130-2, 130-3, and 130-4 transmit the pressures “f′” and “f″” in the entire longitudinal direction of the wiper strip 150. As a result, the wiper blade 100 according to the embodiment of the present invention performs wiping while causing the wiper strip 150 to be in close contact with the glass of the vehicle.

Although the above description assumes that two auxiliary levers, four yoke levers, and two connection members are included, more or fewer auxiliary levers, yoke levers, and the connection members may be provided.

Although embodiments of the present invention were described above, these are just examples and do not intend to limit the present invention. Further, the present invention may be modified and applied in various ways not mentioned above, without departing from the essential features of the present invention, by those skilled in the art. For example, the components described in detail in the embodiments of the present invention may be modified or replaced. Further, mutually different configurations related to various modifications and applications are included in the scope of the present invention, which is described in the accompanying claims.

What is claimed is:

1. A wiper blade comprising:
a main lever which is fastened to a wiper arm;
auxiliary levers which are connected to the main lever;
connection members which connect the main lever and the auxiliary levers;
a plurality of yoke levers which are coupled to the main lever and the auxiliary levers; and
a wiper strip which is supported by the plurality of yoke levers,
wherein the connection members comprise:
a base; and
a pair of fixing portions which extends from the base and is inserted and fixed to the main lever and the auxiliary levers respectively.

2. The wiper blade according to claim 1, wherein the base has an arch shape.

3. The wiper blade according to claim 1, wherein the main lever and the auxiliary levers comprise fixing grooves, and wherein the pair of fixing portions is inserted and fixed respectively to the fixing grooves formed in the main lever and the auxiliary levers, so that the main lever is connected to the auxiliary levers.

4. The wiper blade according to claim 1, wherein the pair of fixing portions has an elastic protrusion.

5. The wiper blade according to claim 5, wherein the main lever and the auxiliary levers comprise, respectively, a catching protrusion by which the protrusion is caught and fastened.

6. The wiper blade according to claim 1, wherein the connection members are made of an elastic material.

7. The wiper blade according to claim 1, wherein the connection members are leaf springs.
